(19) United States
(12) Patent Application Publication
(10) Pub. No.: US 2015/0220124 A1
(43) Pub. Date: Aug. 6, 2015

(54) POWER CONNECTIVITY MONITORING FOR COMPUTING SYSTEMS

(71) Applicant: Microsoft Corporation, Redmond, WA (US)

(72) Inventor: Tim LaBerge, Sammamish, WA (US)

(73) Assignee: Microsoft Corporation, Redmond, WA (US)

(21) Appl. No.: 14/173,654

(22) Filed: Feb. 5, 2014

(51) Int. Cl. G06F 1/26

(52) U.S. Cl. CPC G06F 1/26

(57) ABSTRACT

Various techniques for automated power connectivity monitoring are disclosed herein. In one embodiment, a method for detecting power connectivity in a computing system includes transmitting a PDU message to a processing unit via a power outlet of a PDU. In response, a unit message from the processing unit is received via the power outlet. The unit message contains a distinct power inlet identifier associated with a power inlet of the processing unit. The method then includes identifying a power path that includes the power outlet at which the unit message is received and the power inlet identified by the distinct power inlet identifier contained in the unit message.

### BACKGROUND

Modern data centers and other types of facilities can include thousands of interconnected servers, input/output modules, routers, switches, data storage components (e.g., disk arrays, disk controllers, RAID, tape libraries), and other processing units supported by a utility infrastructure. The utility infrastructure can include transformers, rectifiers, voltage regulators, circuit breakers, power distribution units, and/or other types of electrical/mechanical components that supply, condition, and/or distribute power to the individual processing units.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In certain facilities, power distribution units (“PDUs”) distribute power from an energy source (e.g., a power grid) to a number of servers, input/output modules, routers, switches, and/or other types of processing units via multiple power outlets (or power ports). The power outlets of the PDUs may be remotely switchable to allow an operator (or application) to remotely power up/down a particular one of the power outlets, and thus to supply/remove power to/from a corresponding processing unit. Proper operation of this arrangement requires correct mapping of the processing units to corresponding power outlets of the PDUs. Otherwise, a remote command may power up/down an unintended processing unit, and thus causing potential operational failures, service interruptions, or even safety hazards.

Currently, verifying mapping between power inlets of the processing units and power outlets of the PDUs often requires manual tracing of power cables (or other power lines). Thus, the process can be labor intensive, expensive, and prone to human error. Also, after manual tracing of the power cables, the mapping may still be inaccurate if someone unintentionally or maliciously moves one of the power cables to a different power outlet or a processing unit. To re-verify the mapping, additional manual tracing would be needed.

Several embodiments of the present technology are directed to automated power connectivity monitoring for mapping power inlets of the processing units to power outlets of PDUs. In one embodiment, a PDU can transmit a PDU message via a power outlet of the PDU through a power cable. In response, the PDU then receives a unit message from a processing unit that is electrically connected to the power outlet by the power cable. The unit message can include a distinct power inlet identifier identifying, for example, a power inlet to which the power cable is connected and/or the processing unit that has the power inlet.

Based on the distinct power inlet identifier, the PDU can then identify a power path through which the PDU delivers power to the processing unit. For instance, the power path can include the power outlet at which the unit message is received and the power inlet identified by the distinct power inlet identifier. The power outlet of the PDU can also be identified by a distinct power outlet identifier. In other embodiments, the processing unit (and/or the PDU) may broadcast one or more messages containing the distinct power inlet (or outlet) identifier on a continuous, periodic, or other suitable basis.

### BRIEF DESCRIPTION OF THE DRAWINGS

FIG. 1 is a schematic diagram illustrating a computing framework having automated power connectivity monitoring in accordance with embodiments of the present technology.

FIG. 2 is a block diagram showing software modules of certain components of the computing framework of FIG. 1 in accordance with embodiments of the present technology.

FIGS. 3A and 3B are example data schemas of a port identifier and a connectivity record in accordance with embodiments of the present technology.

FIG. 4 is a block diagram showing software modules of certain components of the computing framework of FIG. 1 in accordance with additional embodiments of the present technology.

FIGS. 5A-5C are schematic block diagrams illustrating examples of power connectivity in accordance with additional embodiments of the present technology.

FIG. 6 is a flow diagram illustrating a process for automated power connectivity monitoring in accordance with embodiments of the present technology.

FIG. 7 is a computing device suitable for certain components of the computing framework in FIG. 1.

### DETAILED DESCRIPTION

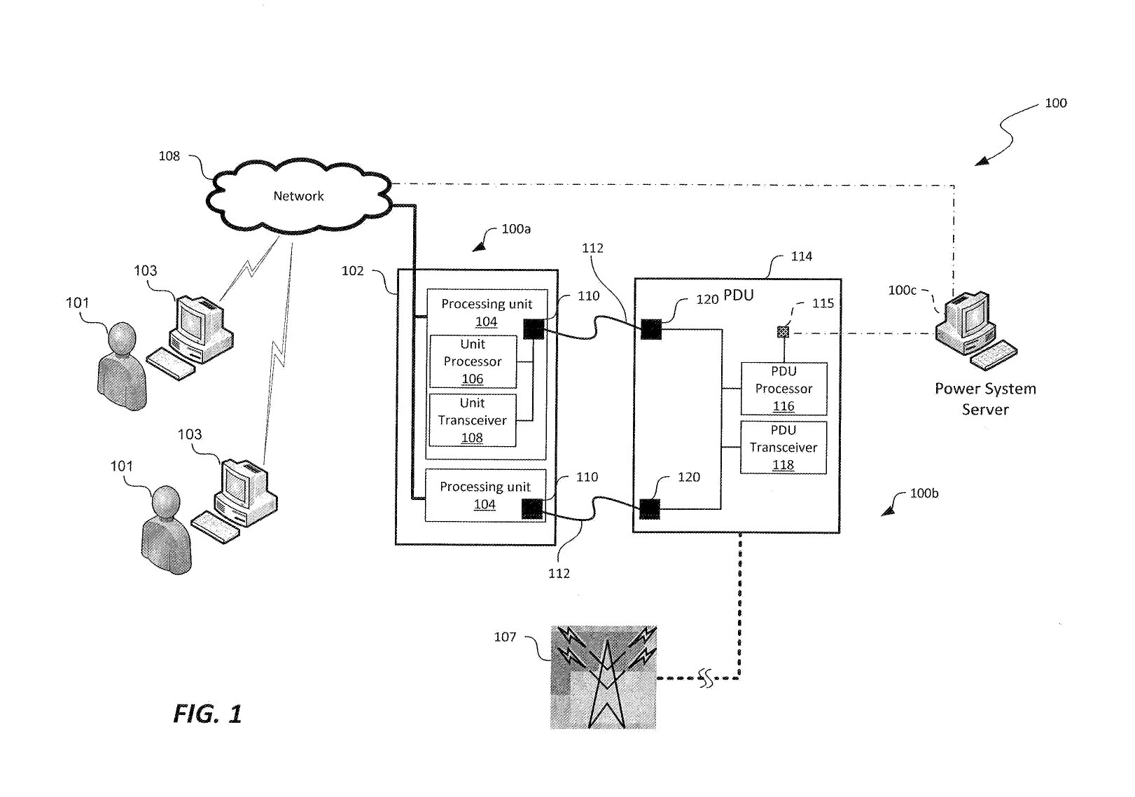

Certain embodiments of systems, devices, components, modules, routines, and processes for backup power management are described below. In the following description, example software codes, values, and other specific details are included to provide a thorough understanding of certain embodiments of the present technology. A person skilled in the relevant art will also understand that the technology may have additional embodiments. The technology may also be practiced without several of the details of the embodiments described below with reference to FIGS. 1-7.

As used herein, the term “power distribution unit” generally refers to an apparatus with multiple power outlets configured to distribute electrical power from a power source to multiple electrical devices. The term “power outlet” generally refers to an electrical interface through which electrical power is provided to an electrical device. For example, a power outlet can include one or more of plugs, sockets, ground-fault interrupters, power wiring terminals, solenoids, electrical contacts, and/or other suitable electrical/mechanical components. Each of the power outlets may be identified by a distinct power outlet identifier.

PDUs may be floor mounted, cabinet mounted, rack mounted, or may have other suitable structural profiles. PDUs may also contain one or more electrical/mechanical components. For example, PDUs can include one or more power conversion/conditioning components that transform one or more larger capacity power feeds into a number of lower capacity distributed power feeds. Example conversion/conditioning components can include transformers, circuit breakers, power filters, and power rectifiers. In other examples, PDUs may simply include a number of appliance or interconnection couplers. PDUs may also allow remote access, for example, via an RS-232, Ethernet, and/or other suitable types of connection and according to a network protocol such as Telnet, secure shell, simple network management protocol, or other suitable protocols.

Also used herein, the term “processing unit” generally refers to an electronic apparatus configured to perform logic comparisons, arithmetic calculations, electronic communications, electronic input/output, and/or other suitable functions. Example processing units can include computing systems (e.g., servers, computers, etc.), computing devices (e.g., logic processors, network routers, network switches, network interface cards, data storage devices, etc.), or other suitable types of electronic apparatus.

A processing unit can have one or more power inlets each identified by a distinct power inlet identifier. As used herein, the term “power inlet” generally refers to an electrical interface through which electrical power is received. For example, a power inlet can include one or more appliance inlets, electrical switches, circuit breakers, voltage selectors, electromagnetic interference filters, surge protectors, ground fault interrupters, and/or other suitable electrical/mechanical components.

In certain embodiments, the power inlet/outlet identifiers (collectively referred to herein as “port identifiers”) may be generally similar to one another. An example port identifier may include one or more of a device type, a model, a serial number, a port type, a port identifier, a port number, and/or include other suitable information. In other examples, port identifiers may contain other suitable information in other suitable arrangements. In certain embodiments, port identifiers may be assigned by manufacturers of PDUs and/or processing units and stored in, e.g., a read-only memory thereon. In other embodiments, port identifiers may be assigned by, for example, a network server, an application, an operator, and/or other suitable entities.

As discussed above, power connectivity information such as mapping between the processing units and corresponding power outlets of PDUs can be labor intensive, expensive, and prone to human error. Several embodiments of the present technology implement a scheme of automated discovery of mapping between power inlets of the processing units and the power outlets of PDUs. As a result, the power connectivity information may be efficiently and accurately verified, obtained, and/or updated, as described in more detail below.

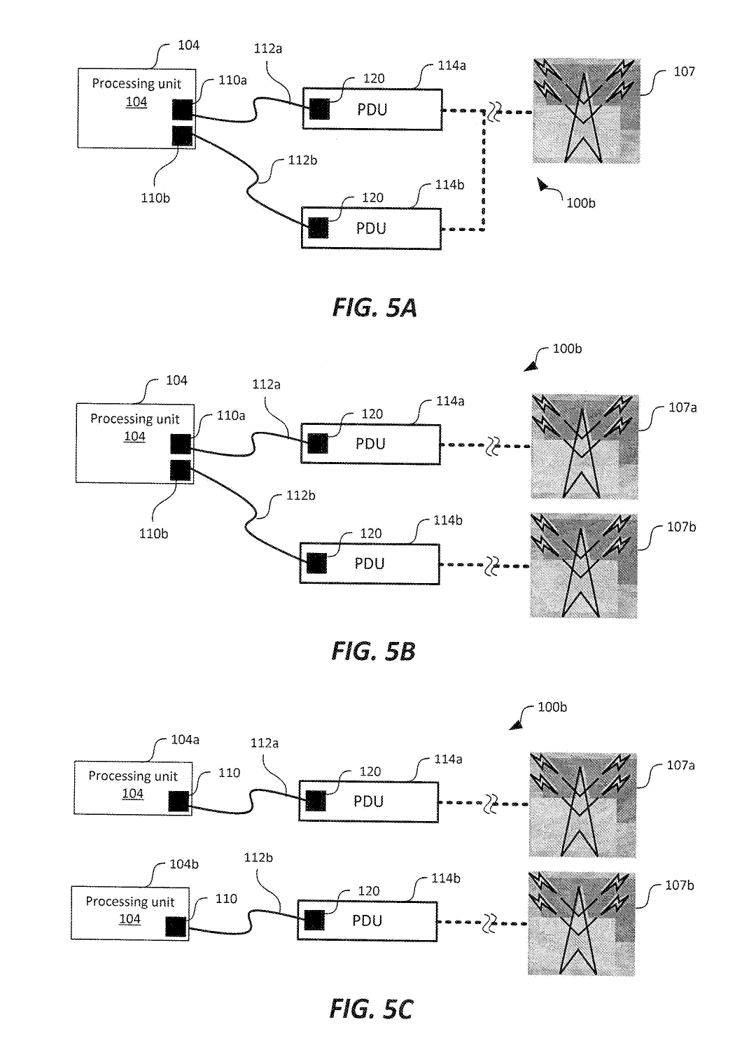

FIG. 1 is a schematic diagram illustrating a computing framework 100 having automated power connectivity monitoring in accordance with embodiments of the present technology. As shown in FIG. 1, the computing framework 100 can include a computing system 100a, a utility infrastructure 100b that supports the computing system 100a, and an optional power system server 100c in communication with one another. Even though certain components of the computing framework 100 are shown in FIG. 1, in other embodiments, the computing framework 100 may also include other suitable electrical/mechanical components in similar or different arrangements, examples of which are described in more detail with reference to FIGS. 5A-5C.

As shown in FIG. 1, the computing system 100a can include multiple processing units 104 contained in a computer cabinet 102. A network 108 couples the processing units 104 to client devices 103 (e.g., desktop computers) individually associated with users 101. The computer cabinet 102 can have any suitable shape and size to house the processing units 104 in racks and/or in other suitable arrangements. Though only one computer cabinet 102 is shown in FIG. 1, in other embodiments, the computing system 100a can include any suitable number of computer cabinets 102 with any suitable number of corresponding processing units 104.

The network 108 can include a wired medium (e.g., twisted pair, coaxial, untwisted pair, or optic fiber), a wireless medium (e.g., terrestrial microwave, cellular systems, WI-FI, wireless LANs, Bluetooth, infrared, near field communication, ultra-wide band, or free space optics), or a combination of wired and wireless media. The network 108 may operate according to Ethernet, token ring, asynchronous transfer mode, and/or other suitable protocols. In further embodiments, the network 108 can also include routers, switches, modems, and/or other suitable computing and/or communications components in any suitable arrangements.

The processing units 104 can be configured to implement one or more computing applications, network communications, input/output capabilities, and/or other suitable functionalities, for example, as requested by the users 101. In certain embodiments, the processing units 104 can include web servers, application servers, database servers, and/or other suitable computing components. In other embodiments, the processing units can include routers, network switches, analog/digital input/output modules, modems, and/or other suitable electronic components. FIG. 1 shows two processing units 104 with one shown in details for illustration purposes. In other embodiments, any other suitable numbers of processing units 104 with generally similar or different configurations may reside in the computing cabinet 102 or additional computing cabinets (not shown).

In the illustrated embodiment, the utility infrastructure 100b includes a power source 107 (e.g., an electrical grid) and a PDU 114 configured to distribute electrical power to the processing units 104. The utility infrastructure 100b may also include a backup power system (not shown) configured to provide power to the processing units 104 when the power source 107 is unavailable. The components of the utility infrastructure 100b shown in FIG. 1 are examples for illustrating aspects of the present technology. In other embodiments, the utility infrastructure 100b may include one or more HVAC systems, substations, and/or other components in any suitable arrangements.

As shown in FIG. 1, the processing unit 104 can include a unit processor 106, a unit transceiver 108, and a power inlet 110 operatively coupled to one another. Operations of the foregoing components of the processing unit 104 are described in more detail below. The PDU 114 can include a PDU processor 116, a PDU transceiver 118, and multiple power outlets 120. Two power outlets 120 are shown in FIG. 1 for illustration purposes with each being electrically coupled to one of the processing units 104 via a power cable 112. In other embodiments, the PDU 114 may include any suitable number of power outlets 120 in any suitable arrangements.

Optionally, the PDU 114 may also include a communications port 115 in communication with the power system server 100c. The communications port 115 may include any network interface that allows communications between the PDU 114 with the optional power system server 100c. In FIG. 1, the optional power system server 100c is shown as a standalone computing device. In other embodiments, the power system sever 100c may include one of the processing units 104, or a software service running on one of the processing units 104.

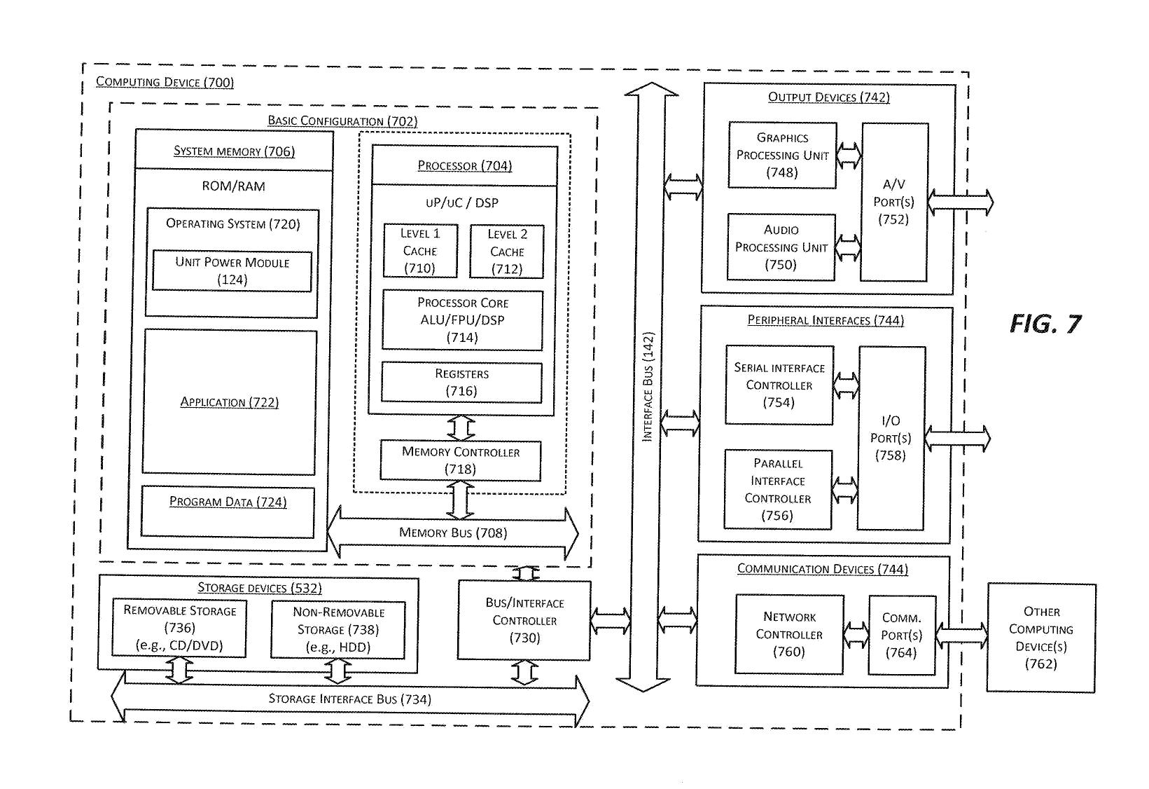

The unit processor 106 and the PDU processor 116 may include any suitable logic processors configured to execute computing instructions. Example processors are described in more detail below with reference to FIG. 7. The unit transceiver 108 and the PDU transceiver 118 can individually include a transceiver configured to transmit and receive messages via the power cables 112 according to the power-line communications protocol, X10, DC-BUS, and/or other suitable power-line communications protocols. An example transceiver suitable for the unit transceiver 108 and the PDU transceiver 118 is a power-line transceiver Model No. ST7538Q provided by STMicroelectronics of Geneva, Switzerland.

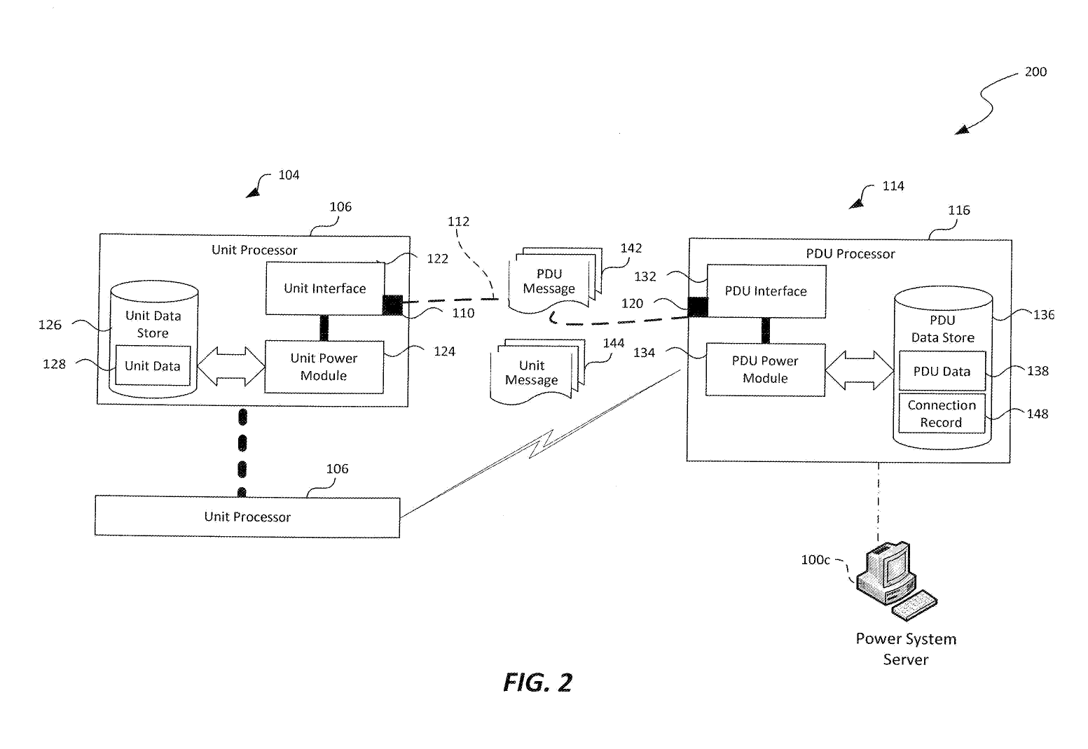

The PDU 114 and/or the processing units 104 can be configured for automated power connectivity monitoring therebetween. For example, in one embodiment, the PDU processor 116 can cause the PDU transceiver 118 to transmit a PDU message 142 (shown in FIG. 2) via the corresponding power outlet 120 through the corresponding power cable 112. The PDU message 142 can include a request for identification and/or a distinct power outlet identifier associated with the power outlet 120. The processing unit 104 can then respond by causing the unit transceiver 108 to transmit a unit message 144 (shown in FIG. 2) via the power inlet 110 through which the PDU message 142 is received. The unit message 144 can contain a distinct power inlet identifier associated with the power inlet 110.

The PDU 114 and/or the processing units 104 may then identify a power path therebetween. For example, the PDU 114 may identify the power path that includes the power inlet 110 identified by the distinct power inlet identifier, and the power outlet 120 through which the unit message 144 is received and/or identified by the distinct power outlet identifier. In another example, the processing units 104 can identify a power path that includes the power outlet 120 identified by the distinct power outlet identifier, and the power inlet 110 through which the PDU message 142 is received and/or identified by the distinct power inlet identifier. Thus, power connectivity between the PDU 114 and the processing units 104 may be automatically detected in the computing framework 100. Thus, costs for verifying power connectivity may be reduced while improved accuracy when compared to conventional systems, as described in more detail below with reference to FIG. 2.

FIG. 2 is a block diagram 200 showing software modules of certain components of the computing framework 100 in FIG. 1 in accordance with embodiments of the present technology. As shown in FIG. 2, the unit processor 106 is in communication with the PDU processor 116 via the power cable 112 (shown in phantom lines for clarity). Only one unit processor 106 and associated software modules are shown in FIG. 2 for illustration purposes. Additional unit processors 106 in the same or different processing units 104 may include similar or different software modules as those illustrated in FIG. 2.

In FIG. 2 and in other Figures herein, individual software modules, components, and routines may be a computer program, procedure, or process written as source code in C, C++, Java, and/or other suitable programming languages. The computer programs, procedures, or processes may be compiled into intermediate, object or machine code and presented for execution by a processor of a personal computer, a network server, a laptop computer, a smart phone, a tablet, and/or other suitable computing devices. Various implementations of the source, intermediate, and/or object code and associated data may be stored in one or more computer readable storage media that include read-only memory, random-access memory, magnetic disk storage media, optical storage media, flash memory devices, and/or other suitable media. As used herein, the term “computer readable storage medium” excludes propagated signals, per se.

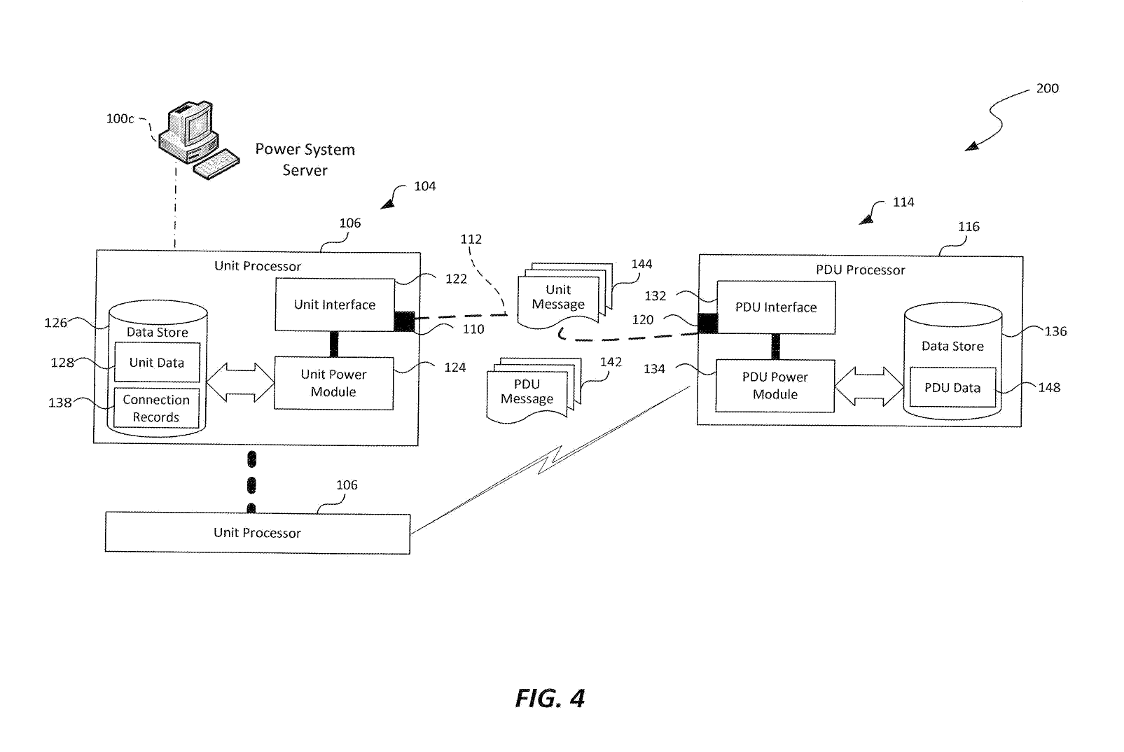

As shown in FIG. 2, the unit processor 106 can include a unit interface 122, a unit power module 124, and a unit data store 126 operatively coupled to one another. The PDU processor 116 can include a PDU interface 132, a PDU power module 134, and a PDU data store 136 operatively coupled to one another. In the illustrated embodiment, the unit data store 126 contains records of unit data 128, for example, data representing a distinct power inlet identifier and/or other suitable information associated with the processing unit 104. The PDU data store 136 contains records of PDU data 138 and connection record 148. The PDU data 138 can include, for example, data representing the distinct power outlet identifiers of the power outlets 120 (FIG. 1) of the PDU 114 and/or other suitable information. In other embodiments, the unit data store 126 and/or the PDU data store 136 may contain different records, as described below with reference to FIG. 4.

The unit interface 122 and the PDU interface 132 (collectively referred to as “communications interfaces”) can be configured to facilitate communications between the processing unit 104 and the PDU 114. The communications interfaces can include any suitable combinations of hardware and/or software components configured to implement power-line communications protocol, X10, DC-BUS, and/or other suitable power-line communications protocols. For example, the communications interfaces can include AC/DC converters, filters, modulators, de-modulators, signal repeaters, amplifiers, and/or other suitable components. In other examples, the communications interfaces can also include suitable firmware (e.g., instructions for modulation/de-modulation of signals) in a read-only or other types of memory (not shown).

In certain embodiments, the PDU power module 134 can be configured to instruct the PDU interface 132 to transmit a PDU message 142 via the power outlet 120, through the power cable 112, and via the power inlet 110 to the unit interface 122. The PDU message 142 may contain a request for identification from the unit processor 106 and/or a distinct power outlet identifier associated with the power outlet 120. The unit interface 122 then conveys the PDU message 142 to the unit power module 124. In response, the unit power module 124 may be configured to retrieve the unit data 128 from the unit data store 126 and instruct the unit interface 122 to transmit a unit message 144 via the power inlet 110, through the power cable 112, and via the power outlet 120 to the PDU interface 132. The unit message 144 may contain the distinct power inlet identifier associated with the power inlet 110 (FIG. 1) of the processing unit 104 and/or other suitable information contained in the unit data 128.

The PDU interface 132 then conveys the unit message 144 to the PDU power module 134, which in turn may identify a power path that includes the power outlet 120 through which the unit message 144 is received (and/or identified by the distinct power outlet identifier) and the power inlet 110 identified by the distinct power inlet identifier. The PDU power module 134 can then store the identified power path as data of the connection record 148 and/or transmit such information to the optional power system server 100c.

In other embodiments, the unit power module 124 may provide the distinct power inlet identifier associated with the power inlet 110 of the processing unit 104 and/or other suitable information contained in the unit data 128 without being in response to the PDU message 142. For example, the unit power module 124 may instruct the unit interface 122 to broadcast the unit message 144 containing the distinct power inlet identifier on a continuous, intermittent (e.g., once every 5 minutes), on a connection change, and/or on other suitable basis. In further embodiments, the unit power module 124 may identify a power path based on the distinct power outlet identifier included in the PDU message 142, as described in more detail with reference to FIG. 4.

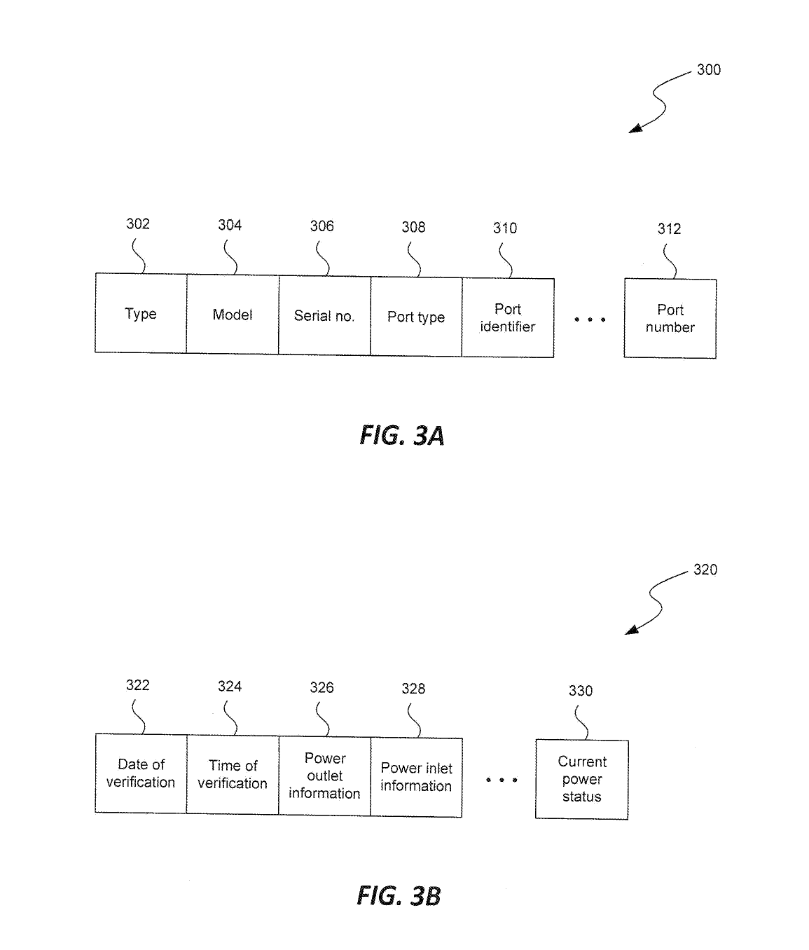

FIGS. 3A and 3B are example data schemas of a port identifier 300 and a connection record 320, respectively, in accordance with embodiments of the present technology. The port identifier 300 can be a distinct power inlet identifier of a power inlet 110 (FIG. 1) on a processing unit 104 (FIG. 1) or a distinct power outlet identifier of a power outlet 120 on a PDU 114 (FIG. 1). As shown in FIG. 3A, in the illustrated embodiment, the port identifier 300 can include a type 302, a model 304, a serial number 306, a port type 308, a port identifier 310, and a port number 312. In other embodiments, the port identifier 300 can include additional, less, and/or different information. In further embodiments, the port identifier 300 can also include a random or select numerical, alphabetic, alphanumerical string, and/or other suitable types of string.

As shown in FIG. 3B, the connectivity record 320 can include a date of verification 322, a time of verification 324, a power outlet information field 326 (e.g., containing a distinct power outlet identifier), a power inlet information field 328 (e.g., containing a distinct power inlet identifier), and a current power status field 330 (e.g., on, off, power cycling, etc.). In other embodiments, the connectivity record 320 can include additional, less, and/or different information.

FIG. 4 is a block diagram showing software modules of certain components of the computing framework 100 of FIG. 1 in accordance with additional embodiments of the present technology. As shown in FIG. 4, the unit power module 124 may be configured to instruct the unit interface 122 to transmit a unit message 144 via the power inlet 110, through the power cable 112, and via the power outlet 120 to the PDU interface 132. The unit message 144 can include a request for identification and/or, a distinct power inlet identifier associated with the power inlet 110.

The PDU interface 132 then conveys the unit message 144 to the PDU power module 134. In response, the PDU power module 134 can be configured to retrieve the PDU data 148 from the PDU data store 136 and instruct the PDU interface 132 to transmit a PDU message 142 to the unit interface 122. The PDU message 142 may contain the distinct power outlet identifier associated with the power outlet 120 (FIG. 1) of the PDU 114 and/or other suitable information contained in the PDU data 148.

The unit interface 122 then conveys the PDU message 142 to the unit power module 124, which in turn identifies a power path that includes the power inlet 110 through which the PDU message 142 is received (and/or identified by the distinct power inlet identifier) and the power outlet 120 identified by the distinct power outlet identifier. The unit power module 124 can then store the identified power path as connection records 138 and/or transmit such information to the optional power system server 100c.

In other embodiments, the PDU power module 134 may provide the distinct power outlet identifier associated with the power outlet 120 and/or other suitable information contained in the PDU data 148 without being in response to the unit message 144. For example, the PDU power module 134 may instruct the PDU interface 132 to broadcast the PDU message 142 containing the distinct power outlet identifier on a continuous, intermittent (e.g., once every 5 minutes), on a connection change, and/or on other suitable basis. In further embodiments, both the PDU power module 134 and the unit power module 124 may be configured to broadcast a message containing a distinct port identifier through the power cable 112. One or both of the PDU power module 134 or the unit power module 124 may identify a power path based on broadcasted the distinct port identifiers.

FIGS. 5A-5C are schematic block diagrams illustrating other examples of the computing framework 100 in accordance with embodiments of the present technology. For example, as shown in FIG. 5A, the processing unit 104 may include a first power inlet 110a and a second power inlet 110b. A first power cable 112a electrically connects the first power inlet 110a to a power outlet 120 of a first PDU 114a. A second power cable 112b electrically connects the second power inlet 110b to a power outlet 120 of a second PDU 114b. Both the first and second PDUs 114a and 114b are electrically connected to the power source 107. As shown in FIG. 5B, the first and second PDUs 114a and 114b are individually connected to a first power source 107a and a second power source 107b, respectively.

As shown in FIG. 5C, a first processing unit 104a can include a power inlet 110 that is electrically connected to a power outlet 120 of a first PDU 114a by a first power cable 112a. A second processing unit 104b can include a power inlet 110 that is electrically connected to a power outlet 120 of a second PDU 114b by a second power cable 112b. The first and second PDUs 114a and 114b are individually connected to a first power source 107a and a second power source 107b, respectively. Even though not shown in FIGS. 5A-5C, the utility infrastructure 100b may have other suitable configurations.

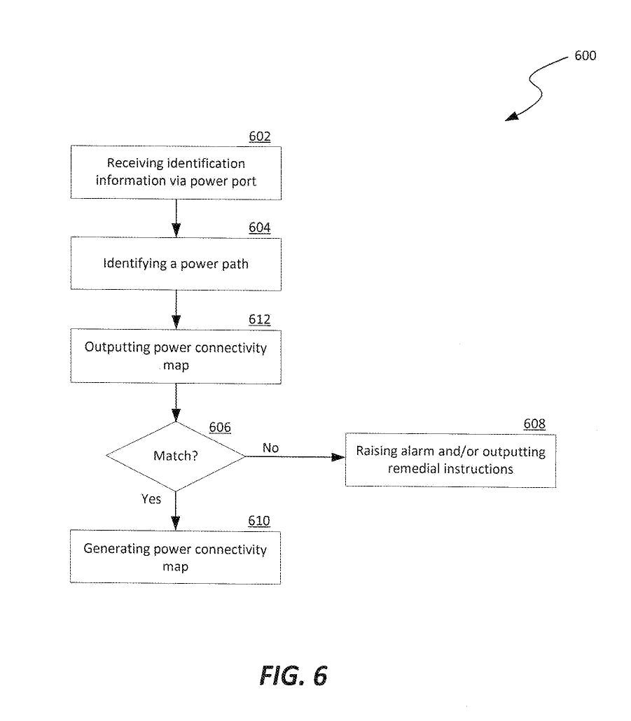

FIG. 6 is a flow diagram illustrating a process 600 of automated power connectivity monitoring in accordance with embodiments of the present technology. Even though the process 600 is described below with reference to the computing framework 100 of FIG. 1 and the components/modules of FIG. 2, the process 600 may also be applied in other systems with additional or different hardware and/or software components.

As shown in FIG. 6, the process 600 can include receiving identification information of an electrically connected device (e.g., the processing unit 104 or the PDU 114 of FIG. 1) via a power port (e.g., the power outlet 120 or the power inlet 110 of FIG. 1) at stage 602. In one embodiment, the identification information may include a distinct port identifier, examples of which are described above with reference to FIG. 3A. In other embodiments, the identification information may include other suitable information. In certain embodiments, the identification information is received in response to a request transmitted via a power port. In other embodiments, the identification information is received as a broadcast from the electrically connected device. In further embodiments, the identification information may be received in other suitable manners.

The process 600 can then include identifying a power path at stage 604 based on the received identification information. For example, in one embodiment, the identified power path can include a power port through which the identification information is received and another power port identified based on the received identification information. In other embodiments, the identified power path may also include an identification of the power cable connected to the electrically connected device. In further embodiments, the identified power path may include any other suitable information. The process 600 may further optionally include outputting the generated power connectivity map at stage 612, for example, on a display of the power system server 100c (FIG. 1).

The process 600 can then optionally include a decision stage 606 to determine if the identified power path matches a target power path by, for example, comparing the power ports associated with the power path. In response to determining that the identified power path does not match the target power path, the process 600 includes raising an alarm (e.g., via an electronic message) and/or outputting suggested remedial instructions, for example, by identifying the correct power outlet, power inlet, and/or power cable at stage 608.

In response to determining that the identified power path matches the target power path, the process 600 optionally includes generating a power connectivity map at stage 610. The connectivity map may be graphical (e.g., by representing each connected device as a node), tabulated (e.g., list pairs of connected devices in a table), and/or have other suitable representations.

FIG. 7 is a computing device 700 suitable for certain components of the computing framework 100 in FIG. 1. For example, the computing device 700 may be suitable for the individual processing units 104, the backup power management controller 114, or the backup power systems 116. In a very basic configuration 702, computing device 700 typically includes one or more processors 704 and a system memory 706. A memory bus 708 may be used for communicating between processor 704 and system memory 706.

Depending on the desired configuration, the processor 704 may be of any type including but not limited to a microprocessor (μP), a microcontroller (μC), a digital signal processor (DSP), or any combination thereof. The processor 704 may include one more levels of caching, such as a level one cache 710 and a level two cache 712, a processor core 714, and registers 716. An example processor core 714 may include an arithmetic logic unit (ALU), a floating point unit (FPU), a digital signal processing core (DSP Core), or any combination thereof. An example memory controller 718 may also be used with processor 704, or in some implementations memory controller 718 may be an internal part of processor 704.

Depending on the desired configuration, the system memory 706 may be of any type including but not limited to volatile memory (such as RAM), non-volatile memory (such as ROM, flash memory, etc.) or any combination thereof. The system memory 706 may include an operating system 720, one or more applications 722, and program data 724. The operating system 720 may include, for example, the unit power module 124. This described basic configuration 702 is illustrated in FIG. 7 by those components within the inner dashed line.

The computing device 700 may have additional features or functionality, and additional interfaces to facilitate communications between basic configuration 702 and any other devices and interfaces. For example, a bus/interface controller 730 may be used to facilitate communications between the basic configuration 702 and one or more data storage devices 732 via a storage interface bus 734. The data storage devices 732 may be removable storage devices 736, non-removable storage devices 738, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 706, removable storage devices 736 and non-removable storage devices 738 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 700. Any such computer storage media may be part of computing device 700. The term “computer storage medium” excludes propagated signals and communication media.

The computing device 700 may also include an interface bus 740 for facilitating communication from various interface devices (e.g., output devices 742, peripheral interfaces 744, and communication devices 746) to the basic configuration 702 via bus/interface controller 730. Example output devices 742 include a graphics processing unit 748 and an audio processing unit 750, which may be configured to communicate to various external devices such as a display or speakers via one or more NV ports 752. Example peripheral interfaces 744 include a serial interface controller 754 or a parallel interface controller 756, which may be configured to communicate with external devices such as input devices (e.g., keyboard, mouse, pen, voice input device, touch input device, etc.) or other peripheral devices (e.g., printer, scanner, etc.) via one or more I/O ports 758. An example communication device 746 includes a network controller 760, which may be arranged to facilitate communications with one or more other computing devices 762 over a network communication link via one or more communication ports 764.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 700 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 700 may also be implemented as a personal computer including both laptop computer and non-laptop computer configurations.

Specific embodiments of the technology have been described above for purposes of illustration. However, various modifications may be made without deviating from the foregoing disclosure. In addition, many of the elements of one embodiment may be combined with other embodiments in addition to or in lieu of the elements of the other embodiments. Accordingly, the technology is not limited except as by the appended claims.

I/We claim:

1. A method for detecting power connectivity in a computing system having a plurality of processing units and a power distribution unit (“PDU”) with a plurality of power outlets, the method comprising:
transmitting a PDU message via a power outlet of the PDU, the PDU message containing a request for identification;
receiving, via the power outlet, a unit message from a processing unit of the computing system in response to the PDU message, the unit message containing a distinct power inlet identifier associated with a power inlet of the processing unit; and
identifying a power path through which the PDU powers the processing unit, the power path including the power outlet at which the unit message is received and the power inlet identified by the distinct power inlet identifier contained in the unit message.

2. The method of claim 1 wherein transmitting the PDU message includes transmitting the PDU message through a power cable electrically connecting the power inlet of the processing unit to the power outlet of the PDU.

3. The method of claim 1 wherein transmitting the PDU message includes transmitting a PDU message through a power cable electrically connecting the power inlet of the processing unit to the power outlet of the PDU while the PDU supplies electrical power to the processing unit via the power outlet, the power cable, and the power inlet.

4. The method of claim 1 wherein the power outlets are individually associated with a distinct power outlet identifier, and wherein identifying the power path includes identifying a power path comprising the power outlet identified by one of the distinct power outlet identifier and the power inlet identified by the distinct power inlet identifier contained in the unit message.

5. The method of claim 1 wherein receiving the unit message includes receiving the unit message via the power outlet of the PDU, the power inlet of the processing unit, and a power cable electrically connecting the power outlet to the power inlet.

6. The method of claim 1 wherein the PDU message further contains a distinct power outlet identifier associated with the power outlet in addition to the request for identification, and wherein identifying the power path includes identifying a power path through which the PDU powers the processing unit, the power path includes:
the power outlet identified by the distinct power outlet identifier; and
the power inlet identified by the distinct power inlet identifier.

7. The method of claim 1 wherein:
the power inlet is a first power inlet;
the distinct power inlet identifier is a first distinct power inlet identifier;
the processing unit also includes a second power inlet associated with a second distinct power inlet identifier;
the power outlet is a first power outlet;
the distinct power outlet identifier is a first power outlet identifier;
the PDU further includes a second power outlet identified by a second distinct power outlet identifier;
transmitting the PDU message includes:
transmitting a first PDU message via the first power outlet to the first power inlet of the processing unit; and
transmitting a second PDU message via the second power outlet to the second power inlet of the processing unit;
receiving the unit message includes:
receiving a first unit message from the processing unit via the first power outlet, the first unit message containing the first distinct power inlet identifier; and
receiving a second unit message from the processing unit via the second power outlet, the second unit message containing a second distinct power inlet identifier;
identifying the power path includes:
identifying a first power path that comprises the first power outlet identified by the first distinct power outlet identifier and the first power inlet of the processing unit identified by the first distinct power inlet identifier; and
identifying a second power path that comprises the second power outlet identified by the second distinct power outlet identifier and the second power inlet of the processing unit identified by the second distinct power inlet identifier.

8. The method of claim 1, further comprising:
comparing the identified power path with a target power path associated with the power outlet of the PDU; and
in response to the identified power path differs from the target power path, performing at least one of:
indicating an error in power connectivity; or
outputting an instruction to correct the error in power connectivity.

9. The method of claim 1, further comprising:
repeating the transmitting, receiving, and identifying operations for all of the power outlets of the power distribution unit;
generating a power connectivity map based on the identified power paths through which the power distribution unit powers the processing unit; and
outputting the generated power connectivity map on a computer display.

10. A power distribution unit (“PDU”) for distributing power to one or more processing units, comprising:
a plurality of power outlets;
a transceiver operatively coupled to the power outlets and configured to receive, via one of the power outlets of the PDU, a message from a processing unit, the message containing a distinct power inlet identifier associated with a power inlet of the processing unit; and
a computing processor operatively coupled to the transceiver, the computing processor being configured to identify a power path through which the PDU powers the processing unit, the power path comprising:
the power outlet through which the message is received; and
the power inlet of the processing unit identified by the distinct power inlet identifier contained in the received message.

11. The PDU of claim 10 wherein:
the transceiver is configured to transmit a PDU message via the power outlet, the PDU message containing a request for identification; and
the received message is in response to the transmitted PDU message.

12. The PDU of claim 10 wherein:
the transceiver is configured to transmit a PDU message via each of the power outlets of the PDU, the PDU messages individually containing a request for identification; and
the received message is in response to one of the transmitted PDU messages.

13. The PDU of claim 10 wherein:
the transceiver is configured to transmit a PDU message via the power outlet of the PDU, the PDU message containing a request for identification; and
the computing processor is also configured to indicate that no processing unit is electrically connected to the power outlet through which the PDU message is transmitted in response to not receiving a reply in a pre-determined period of time.

14. The PDU of claim 10 wherein:
the power outlets are individually associated with a distinct power outlet identifier; and
the power path comprising:
the power outlet identified by one of the distinct power outlet identifiers; and
the power inlet of the processing unit identified by the distinct power inlet identifier contained in the received message.

15. A computing device electrically connected to a power distribution unit (“PDU”), comprising:
a power inlet;
a transceiver operatively coupled to the power inlet;
a computing processor and memory operatively coupled to the transceiver, the memory containing instructions that, when executed by the computing processor, cause the computing processor to perform a process comprising:
receiving, at the transceiver and via the power inlet, a message from the PDU, the received message containing a distinct power outlet identifier associated with a power outlet of the PDU electrically connected to the power inlet; and
identifying a power path through which the processing unit receives power from the PDU, the power path comprising:
the power inlet through which the message from the PDU is received; and
the power outlet of the PDU identified by the distinct power outlet identifier contained in the received message.

16. The computing device of claim 15 wherein the process performed by the computing processor further includes:
transmitting a message via the power inlet to the PDU, the transmitted message containing a request for identification; and
the received message is in response to the transmitted message.

17. The computing device of claim 15 wherein receiving the message includes receiving a message indicating a change in the distinct power outlet identifier.

18. The computing device of claim 15 wherein:
the power inlet is associated with a distinct power inlet identifier; and
the process performed by the computing processor further includes causing the transceiver to periodically broadcast a message containing data representing the distinct power inlet identifier via the power inlet.

19. The computing device of claim 15 wherein:
the power inlet is associated with a distinct power inlet identifier; and
identifying the power path includes identifying a power path that includes:
the power inlet identified by the distinct power inlet identifier; and
the power outlet of the PDU identified by the distinct power outlet identifier contained in the received message.

20. The computing device of claim 15 wherein receiving the message from the PDU includes receiving, at the transceiver and via the power inlet, a plurality of messages from the PDU on a continuous or periodic basis.
